(19) United States
(12) Patent Application Publication
(10) Pub. No.: US 2017/0032427 A1
(43) Pub. Date: Feb. 2, 2017

(54) CUSTOMIZED LEAD GENERATION

(71) Applicant: LinkedIn Corporation, Mountain View, CA (US)

(72) Inventors: Divye Raj Khilnani, Sunnyvale, CA (US); Nihar N. Mehta, Sunnyvale, CA (US); Ashvin Kannan, Sunnyvale, CA (US)

(21) Appl. No.: 15/087,361

(22) Filed: Mar. 31, 2016

Related U.S. Application Data
(60) Provisional application No. 62/199,619, filed on Jul. 31, 2015.

(51) Int. Cl. G06Q 30/02; G06Q 50/00

(52) U.S. Cl. CPC G06Q 30/0276; G06Q 30/0247; G06Q 50/01

(57) ABSTRACT

A social network system includes a machine-readable memory storing computer-executable instructions and a plurality of member data elements associated with a member, one or more hardware processors having executed the computer-executable instructions, configure the social network system to provide an interface to a content provider allowing the content provider to define a lead rule for a cost-per-lead (CPL) campaign, the lead rule including a lead action and a lead content item, the lead action identifies a member action relative to the lead content item, receive the defined lead rule into the memory, activate the CPL campaign including the defined lead rule, transmit the lead content item to the member, receive indication that the member has performed the lead action, and provide the member as a lead to the content provider, including providing a first member data element of the plurality of member data elements to the content provider.

### RELATED APPLICATIONS

This application claims the benefit of priority to U.S. Provisional Patent Application Ser. No. 62/199,619, filed Jul. 31, 2015, herein incorporated by reference in its entirety.

### TECHNICAL FIELD

This application relates generally to the technical field of internet marketing and, in one specific example, to systems and methods for providing customized lead generation for content providers within a social media environment.

### BACKGROUND

Online advertising is a form of marketing and advertising which uses the Internet to deliver promotional marketing messages to consumers. Online marketing channels include email marketing, search engine marketing, social media marketing, mobile advertising, and so on.

### BRIEF DESCRIPTION OF THE DRAWINGS

Some embodiments are illustrated by way of example and not limitation in the figures of the accompanying drawings.

FIG. 1 is a network diagram illustrating a network environment suitable for a social network service implementing a lead generation module, according to some example embodiments.

FIG. 2 is a block diagram illustrating components of an example social network system, according to some example embodiments.

FIG. 3 is a diagram of the example lead generation module shown in FIG. 2.

FIG. 4 is a flow chart illustrating operations of the lead generation module in performing a method for providing lead generation in an online advertising campaign, according to various embodiments.

FIG. 5 is a block diagram illustrating components of a machine, according to some example embodiments, able to read instructions from a machine-readable medium and perform any one or more of the methodologies discussed herein.

### DETAILED DESCRIPTION

Example methods and systems are directed to techniques for providing lead generation to online content providers (e.g., advertisers) in an online advertisement campaign. More specifically, the present disclosure relates to methods, systems, and computer program products for providing lead generation campaigns that are customizable by the advertiser based on what a lead means for that advertiser, such as a perceived value per lead, and what action(s) by targeted users (e.g., members of a social network) constitute a lead for that advertiser.

While email marketing remains an online advertising channel, list maintenance, content personalization, over-saturation, and mobile optimization remain among the top email marketing challenges. Meanwhile, mobile devices are playing an increasingly important role in reaching prospects, despite mobile optimization hurdles.

Additionally, online advertising channels have become saturated, and as a result, a recipient may not see an advertisement or may simply ignore an advertisement. To ensure an effective advertisement campaign, a social network can incorporate techniques to increase visibility of the advertisement to its members.

In some instances, a social network can utilize its platform to connect advertisers directly with members on the social network to ensure that important messages are received by the intended recipient. For example, a personalized, one-to-one communication between the advertiser and the member can increase the likelihood that a message is received and read by the recipient.

A social network service described herein allows advertisers to selectively send members of the social network (“targeted members”) personalized messages, advertisements, or other content items from the advertiser. A lead generation module, also described herein, enables advertisers to define or customize what a “lead” constitutes to them, based on the advertiser's objectives (e.g., what action(s) taken by and/or information obtained about a target member of a social media site), and an associated value that the advertiser attributes to each lead generated on the social network. More specifically, the advertiser creates a “lead rule” that defines what action(s) (“lead action(s)”) that, when taken by a targeted member, result in the “generation” of a lead. For example, a business entity may engage the social network service, and the lead generation module, in a promotional campaign to promote an upcoming seminar or webinar. The advertiser may define a “registration” lead rule, such as “register for the seminar,” or an “information” lead rule, such as “request information about the seminar.” Further, the advertiser may define a “lead value” for each lead rule, such as $25.00 for each registration lead, and $5.00 for each information lead.

The lead generation module also enables the advertiser to define a “lead content item” (e.g., an advertisement with scripting) associated with each lead rule. In the example embodiment, the lead content item is configured with one or more lead actions from the lead rule. When the targeted member engages with the lead content item in a pre-defined way (e.g., clicking on the lead content item, or entering data into the lead content item, or performing some action that activates the lead content item's scripting), the lead action is satisfied, thereby fulfilling a lead as defined by the advertiser. Continuing the above example, the advertiser may define a lead content item with text or graphic showing information about the upcoming seminar, such as “Seminar XYZ, July 3^{rd} and 4^{th}, San Francisco, Calif.” In addition, the advertiser may configure a button within the lead content item, such as “Request Information”, or “Register Now.” As such, the lead action may be defined as having a member click on the button to request information, or to register, or be directed to additional content (e.g., a registration page) which, once completed and submitted, completes the lead action.

In some embodiments, when the targeted member triggers the lead action, the targeted member may be directed (e.g., within their web browser) to a landing page pre-configured with the lead action (e.g., a registration page for the seminar). In other embodiments, when the targeted member triggers the lead action, the lead generation module executes at least some functionality associated with the lead action. The lead generation module may provide member data as a part of the execution of the lead action. For example, the target member may click on the “Register Now” button, triggering the registration lead action. The lead generation module may populate a pre-configured registration form with member data for the targeted member based on the member initiating the registration, or the lead generation module may provide an email address of the target member to the advertiser (e.g., in a request for more information), or the lead generation module may initiate an email to the target member that includes additional information for the seminar (e.g., an informational flyer). As such, each triggered lead action results in a confirmed lead (e.g., for the social network service). Further, in the example embodiment, each lead is a “one click” lead (e.g., from the perspective of the targeted member), as a single action or click performs the lead action (e.g., without need for the targeted member to go to an intermediary landing page before completing the lead).

Further, as mentioned above, the lead generation module may receive a lead value associated with the lead rule, which may represent, for example, a perceived value of, or a value paid by the advertiser for, each lead generated by the lead generation module (e.g., via the social network service, and as defined by the lead rule). In the example embodiment, the lead generation module uses the lead value to influence aspects of presentation of the lead content item to targeted users. In some embodiments, the lead generation module enables the advertiser to select a “cost per lead” (“CPL”) model for their advertising campaign. The campaign is then configured by the advertiser with one or more lead rules, and associated lead action(s) and lead content item(s), as described above, and the lead value defined by the advertiser.

Once the CPL campaign is configured or active, the lead generation module determines how the campaign is going to be presented based, at least in part, on the lead value (e.g., to improve campaign effectiveness). The lead generation module may select targeted members based on the lead value. The lead generation module may also map the CPL campaign to one or more other models, such as cost per click (CPC) model, or a cost per impression (CPI)/cost per mille (CPM) model, or some hybrid. The lead generation module enhances or maximizes the likelihood of generating leads by leveraging click data and conversion data, for example, based on an effective cost per impression (eCPI).

As a result, the lead generation module described herein overcomes limits associated with current advertisement models, such as cost-per-impression (CPI) and cost-per-click (CPM) models. The lead generation module can help generate leads for a content provider (e.g., an advertiser). In some instances, the lead generation module enables the advertiser to define what a lead means to them, and the lead generation module provides content items to targeted members such that a lead may be generated with a single click from the member. One click lead generation products may be presented to members who have enhanced likelihood to not only click on ads, but also to take subsequent actions, thereby leading to higher quality in lead generation. In comparison to current advertisement models, the lead generation module can better generate leads from members, requiring less input or interaction from the member because the lead information is provided by the social network automatically upon initiation by the member, where in some conventional advertisement models, the additional inputs requirement may scare away some prospective leads.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

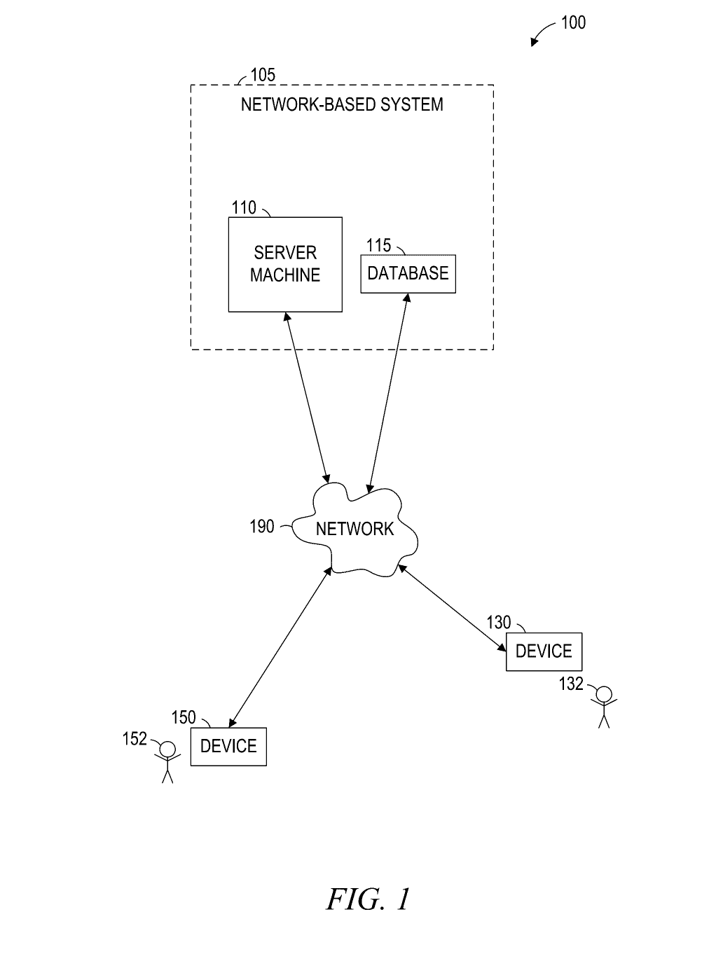

FIG. 1 is a network diagram illustrating a network environment 100 suitable for a social network service implementing a lead generation module, according to some example embodiments. The network environment 100 includes a server machine 110, a database 115, a first device 130 for a first user 132, and a second device 150 for a second user 152, all communicatively coupled to each other via a network 190. The server machine 110 and the database 115 may form all or part of a network-based system 105 (e.g., a cloud-based server system configured to provide one or more services to the devices 130 and 150). The database 115 can store member data (e.g., profile data, social graph data) for the social network service. The server machine 110, the first device 130, and the second device 150 may each be implemented in a computer system, in whole or in part, as described below with respect to FIG. 11.

Also shown in FIG. 1 are the users 132 and 152. One or both of the users 132 and 152 may be a human user (e.g., a human being), a machine user (e.g., a computer configured by a software program to interact with the device 130 or 150), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

Any of the machines, databases 115, or devices 130, 150 shown in FIG. 1 may be implemented in a general-purpose computer modified (e.g., configured or programmed) by software (e.g., one or more software modules) to be a special-purpose computer to perform one or more of the functions described herein for that machine, database 115, or device 130, 150. For example, a computer system able to implement any one or more of the methodologies described herein is discussed below with respect to FIG. 6. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases 115, or devices 130, 150 illustrated in FIG. 1 may be combined into a single machine, database 115, or device 130, 150, and the functions described herein for any single machine, database 115, or device 130, 150 may be subdivided among multiple machines, databases 115, or devices 130, 150.

The network 190 may be any network that enables communication between or among machines, databases 115, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In the example embodiment, the network-based system 105 provides lead generation services to the users 132, 152 of the social network service. Some of the users 132, 152 may be advertisers that configure campaigns leveraging cost per lead (CPL) advertising as described herein. Other users 132, 152 may be “targeted members” of the social network service, or members that are the recipients of content items from the advertisers' CPL campaigns.

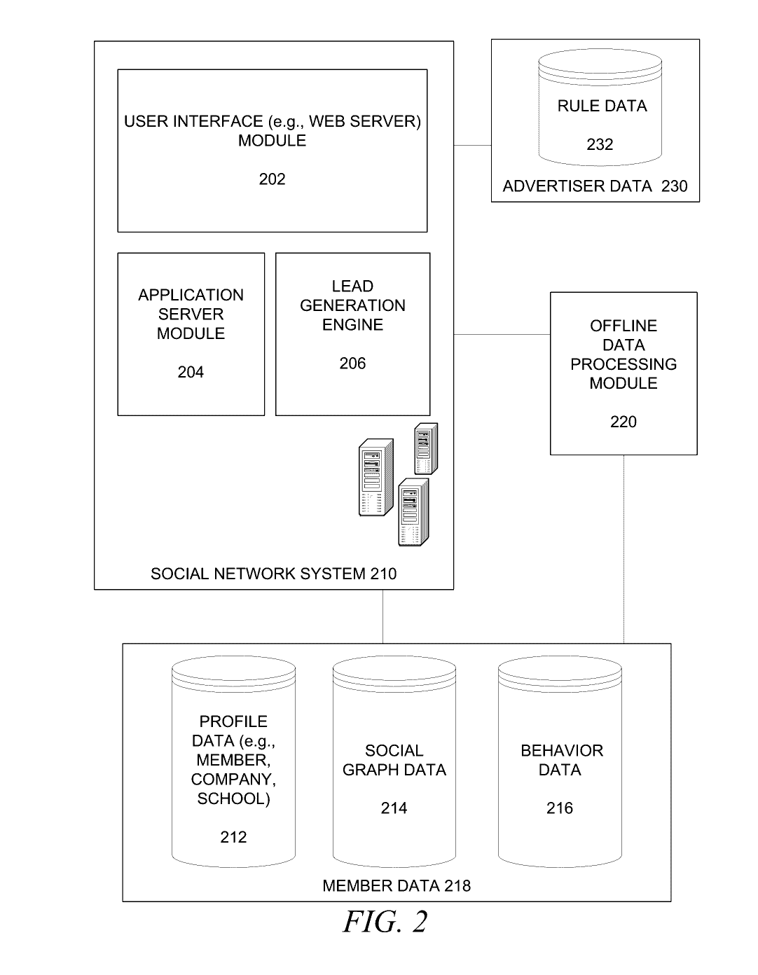

FIG. 2 is a block diagram illustrating components of an example social network system 210 (e.g., providing the social network service(s)), according to some example embodiments. The social network system 210 is an example of the network-based system 105 of FIG. 1. The social network system 210 includes a user interface module 202, an application server module 204, and a lead generation engine 206, all configured to communicate with each other (e.g., via a bus, shared memory, a communications network, or the like).

The social network system 210 (e.g., as provided by the network-based system 105) may provide a broad range of applications and services (the “social networking service(s)”) that allow members (e.g., users 132 and 152) the opportunity to share and receive information, often customized to the interests of the “targeted member.” For example, the social networking service may include a photo sharing application that allows members to upload and share photos with other members. In some example embodiments, members may be able to self-organize into groups (e.g., interest groups) organized around a subject matter or topic of interest, or some of the social networking services may host various job listings providing details of job openings with various organizations (e.g., companies).

The social network system 210 communicates with the database 115 of FIG. 1, such as a database storing member data 218, and a database storing advertiser data 230. The member data 218 can include profile data 212, social graph data 214, and behavior data 216. For example, using profile data 212, and behavior data 216, a potential audience for an advertisement campaign (e.g., a CPL campaign) can be calculated based on the member data 218 of the social network system 210. The advertiser data 230 can include rule data 232 for CPL campaigns of the advertiser. For example, rule data may include lead rules defining what a lead means to an advertiser, as well as lead actions, lead content items, and lead values associated with those lead rules.

In some instances, the lead generation engine 206 can be configured to process data offline or periodically using an offline data processing module 220. For example, the offline data processing module 220 can include Hadoop servers that access the member data 218 periodically (e.g., on a nightly basis). Processing the member data 218 may be computationally intensive; therefore, due to hardware limitations and to ensure reliable performance of the social network, some of the calculation and forecasting can be done offline. For example, some of the parameters (e.g., discounting factor, ratio based on a member attribute) can be calculated offline. Therefore, these parameters can be inputted in the forecast model in real-time in order to almost instantaneously present an estimated cost to an advertiser for an advertisement campaign.

As shown in FIG. 2, database 115 can include several databases for member data 218. The member data 218 includes a database for storing the profile data 212, including both member profile data and profile data 212 for various organizations. Additionally, the member data 218 can store the social graph data 214 and the behavior data 216.

The profile data 212 can include member attributes used in providing leads by the lead generation engine 206. For instance, with many of the social network services provided by the social network system 210, when a user 132, 152 registers to become a member, the member is prompted to provide a variety of personal and employment information to be displayed in the member's personal web page. Such information is commonly referred to as member attributes. The member attributes that are commonly requested and displayed as part of a member's profile includes the member's age, birthdate, gender, interests, contact information, residential address, home town and/or state, spouse and/or family members, educational background (e.g., schools, majors, matriculation and/or graduation dates, etc.), employment history, office location, skills, professional organizations, and so on. In some embodiments, the member attributes may include the various skills that each member has indicated he or she possesses. Additionally, the member attributes may include skills for which a member has been endorsed.

With certain social network services, such as some business or professional network services, the member attributes may include information commonly included in a professional resume or curriculum vitae, such as information about a person's education, the company at which a person is employed, the location of the employer, an industry in which a person is employed, a job title or function, an employment history, skills possessed by a person, professional organizations of which a person is a member, and so on.

Another example of the profile data 212 can include data associated with a company page. For example, when a representative of an entity initially registers the entity with the social network service, the representative may be prompted to provide certain information about the entity. This information may be stored, for example, in the database 115 and displayed on an entity page. This type of profile data 212 can also be used in the forecasting models described herein.

Additionally, social network services provide their users 132, 152 with a mechanism for defining their relationships with other people. This digital representation of real-world relationships is frequently referred to as a social graph.

In some instances, the social graph data 214 can be based on a member's presence within the social network service. For example, consistent with some embodiments, a social graph is implemented with a specialized graph data structure in which various members are represented as nodes connected by edges. The social graph data 214 can be used by the lead generation engine 206 to determine the authenticity of a member's profile page. In some instances, the social graph data 214 can be used to calculate the parameters (e.g., discounting factor, ratio based on a member attribute) for the forecasting models.

In addition to hosting a vast amount of social graph data 214, many of the social network services offered by the social network system 210 maintain behavior data 216. The behavior data 216 can include an access log of when a member has accessed the social network system 210, profile page views, entity page views, newsfeed postings, and clicking on links on the social network system 210. For example, the access log can include the last logon date, the frequency of using the social network system 210, and so on.

Additionally, the behavior data 216 can include information associated with applications and services that allow members the opportunity to share and receive information, often customized to the interests of the member. In some embodiments, members may be able to self-organize into groups, or interest groups, organized around subject matter or a topic of interest.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database 115, or device 130, 150 may be distributed across multiple machines, databases 115, or devices 130, 150.

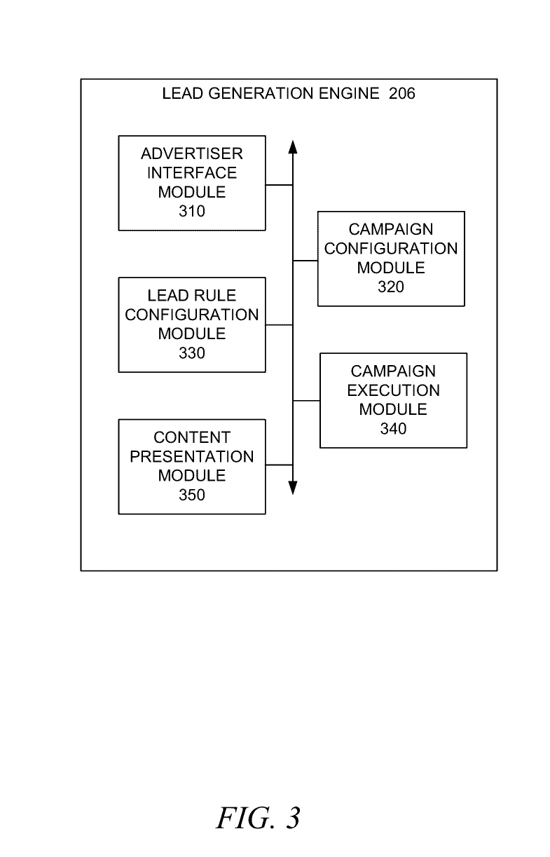

As will be further described with respect to FIGS. 3-5, the lead generation engine 206, in conjunction with the user interface module 202 and the application server module 204, provides lead generation services to the users 132, 152 in the social network system 210 and associated services.

FIG. 3 is a diagram of the example lead generation engine 206 shown in FIG. 2. In the example embodiment, the lead generation engine 206 includes an advertiser interface module 310, a campaign configuration module 320, a lead rule configuration module 330, a campaign execution model 340, and a content presentation module 350.

Advertisers such as users 132, 152 interact with the lead generation engine 206 through the advertiser interface module 310 to build an advertising campaign that implements the lead generation functionalities described herein. The advertiser interface module 310 may present the advertiser with campaign model options to use for a given campaign, such as a “cost per click” (CPC) model, or a “cost per impression” (CPI) or “cost per mille” (CPM) model, as well as a “cost per lead” (CPL) model. In the example embodiment, the advertiser selects the CPL model to define a lead generation campaign.

Through the interface module 310, the advertiser engages the campaign configuration module 320 to build the CPL-based campaign. The advertiser defines what a “lead” means for this campaign (e.g., what action(s) taken by and/or information obtained about a target member of the social network system 210). For example, a lead may include a target member downloading a white paper or e-book (e.g., a product specification sheet for the advertiser's product, or a product manual for the product), or requesting additional information (e.g., providing contact information for the advertiser to use to reach the target member for a discussion), or registering for an offering (e.g., signing up for a webinar, or applying for a job).

The campaign configuration module 320 also enables the advertiser to provide a dollar value (“lead value”) for each lead generated by the lead generation engine 206. This value may represent a perceived economic benefit (e.g., to their business) that the advertiser attributes to this particular type of lead generated on the social network, or an amount that the advertiser is willing to pay for each generated lead. For example, the advertiser may define a lead value of $25.00 for target members that register for the advertiser's seminar, or a lead value of $5.00 for each target member that applies for a job posting being promoted by the advertiser.

The campaign configuration module 320 also enables the advertiser to engage the lead rule configuration module 330 to formalize technical aspects of the lead by creating a lead rule. The lead rule defines a content item (“lead content item”), such as a banner advertisement including a graphic, video, or text (e.g., visual presentation that provides an advertisement to the target member). The lead rule also includes a “lead action” which defines the event(s) that constitute a lead being generated. In other words, the lead action defines what operations will occur when the target member engages with the lead content item such that, once the operations are complete, a lead will have been generated for the advertiser.

More specifically, the lead action defines associated functionality or operations that are executed when the user engages with the lead content item in a particular way. In one example embodiment, the lead rule configuration module 330 provides a list of lead functions or “customized actions” available to the advertiser (e.g., a customized action URL with macros). Such customized actions may include, for example, “apply for this job”, or “register for the event/course”, or “install this app”, and so forth, along with an associated action URL (e.g., provided by and/or supported by the advertiser), which is subsequently passed on to members via macros. The campaign configuration module 320 may further allow the advertisers to customize the text that appears for the lead action.

In some embodiments, the lead action operations (e.g., computer-executable code) may be provided with the lead content item to the target member's device 130, 150, and at least partially performed locally on the device 130, 150 (“client-side operations”). For example, the social network system 210 may provide JAVASCRIPT® or other browser-based, client-side scripting along with the lead content item such that, when the targeted member interacts with the lead content item, the operations are executed by the browser on the local device. For example, in a download action, the client-side operation may be to notify the server that the download is to be initiated by connecting with the server for download and/or opening the file in a particular application on the client device. For another example, in an application install action, the client may be directed to an app store for a particular device type, and to a particular app associated with the advertisement. Some client-side operations may require customization based on device type (e.g., Android-type devices versus iOS-type devices). In some embodiments, this customization may be left to the advertiser (e.g., provided as a part of the lead action operation), where in other embodiments, the lead generation engine 206 may provide this customization (e.g., determining device or operating system type and altering the client-side operations based on such data). In some situations, these lead action operations may also initiate communication back to the social network system 210 for additional processing (e.g., retrieval of member data needed to complete some leads).

In some embodiments, the lead action operations may be performed primarily by the social network system 210 (“server-side operations”). For example, the lead content item may be configured to initiate communication to the social network system 210 to initiate the lead action operations when the targeted member clicks the lead content item. The lead content item may then transmit a lead initiation request to the social network system 210 (e.g., the lead generation engine 206), and the social network system 210 executes the operations defined for the associated with the lead action. For example, the server-side operations may populate fields of a seminar registration request with member data 218 for the targeted member and transmit that data to the advertiser (e.g., a registration server).

Once the advertiser configures and activates the lead rule, the campaign execution module 340 applies the lead rule to generate leads. In other words, the campaign execution module 340 determines how to present the lead content item to members of the social network service.

In some embodiments, the campaign execution module 340 ranks the campaign using social data (e.g., five of member's friends have also registered), member's interest (e.g., member is a job seeker, has taken course on subject X before, and so forth), context (e.g., member is currently in a particular location and using a particular device), and conversion data. The campaign execution module 340 may personalize messages for campaigns.

In some embodiments, the campaign execution module 340 uses the lead value of the CPL campaign to determine how the content item is presented to members. For example, presume that the advertiser's desired objective for a CPL campaign is to have a particular segment of members download a whitepaper or an e-book (e.g., the “lead”) having product details associated with one of the advertiser's flagship product or service offerings. In addition to creating a lead rule for the CPL campaign, the advertiser may have entered a lead value of $5.00 for each lead generated by the lead generation engine 206. The campaign execution module 340 determines how to present the lead content item to members based on the lead value.

More specifically, in some embodiments, the campaign execution module 340 maps the CPL campaign to one or more other models (e.g., CPM or CPC), and this mapping may be based on the lead value. The campaign execution module 340 may compute an effective cost per impression (eCPI) for the campaign. For CPM campaigns, the eCPI=bid/1000. For CPC campaigns, eCPI=bit*pCTRC (predicted cost per return for a click). For CPL campaigns, eCPI=cost per lead*pCTRL (predicted cost per return for a lead). The campaign execution module 340 enhances or maximizes the likelihood of lead generation. For example, click data for ads may be analyzed to determine which members who clicked on the ad ended up taking an action on the advertiser's site such as purchasing something. As such, advertisements may be presented to members who have higher likelihood to not only click on ads, but also to take subsequent actions. This may lead to leads of higher quality, and thus higher value to advertisers.

In some embodiments, the campaign execution module 340 maps the CPL campaign to CPC pricing. For example, if the value of the lead is $50.00, and the likelihood of a member following up on a lead after they click is 10%, then the campaign may be treated as a $5.00 CPC campaign.

During operation, the content presentation module 350 provides the content item, and any associated client-side lead action or operations, to the member device 130, 150 (e.g., through the application server module 204 or the user interface module 202). The content presentation module 350 may also perform some or all of the server-side execution of the lead action described above (e.g., when the targeted member interacts with the lead content item).

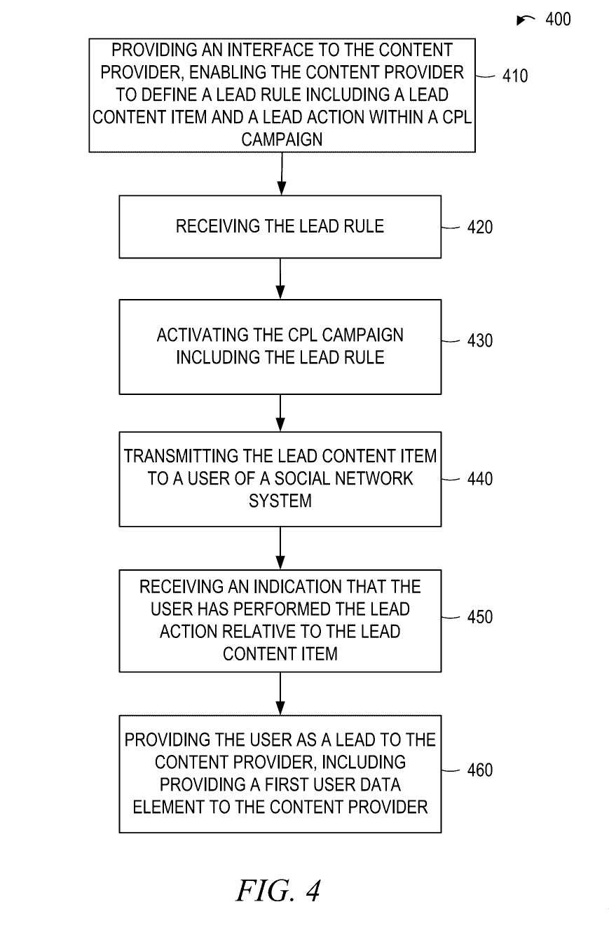

FIG. 4 is a flow chart illustrating operations of the lead generation engine 206 in performing a method 400 for providing lead generation in an online advertising campaign, according to various embodiments. Operations in the method 400 may be performed by the network-based system 105, using modules described above with respect to FIG. 3. As shown in FIG. 4, the method 400 includes operations 410, 420, 430, and 440.

At operation 410, the lead generation engine 206 provides an interface to a content provider via a content provider computing device, the interface enabling the content provider to define a lead rule including a lead action and a lead content item within a cost-per-lead (CPL) campaign of the content provider, the lead action identifies a member action on the social network system relative to the lead content item. At operation 420, the lead generation engine 206 receives the lead rule from the content provider computing device into the memory. At operation 430, the lead generation engine 206 activates the CPL campaign including the lead rule. At operation 440, the lead generation engine 206 transmits the lead content item to a member of the social network system. At operation 450, the lead generation engine 206 receives an indication that the member has performed the lead action relative to the lead content item. At operation 460, the lead generation engine 206 provides the member as a lead to the content provider under the CPL campaign, including providing to the content provider a first member data element of a plurality of member data elements associated with the member.

In some embodiments, the lead action includes only a single click input action, and providing the member as a lead includes providing the first member data element in response to the single click input action. In some embodiments, the lead action includes one or more of downloading a content item and requesting installation of an application. In some embodiments, transmitting the lead content item to the member further includes requesting member input data associated with the lead, wherein the lead action includes receiving the member input data, the first member data element being the member input data and, in some embodiments, the lead action includes one or more of registering for an offering and submitting a request for information.

In some embodiments, the method 400 also includes receiving a lead value associated with the CPL campaign, the lead value identifying a dollar value for providing the lead to the content provider and determining the user from a plurality of users based on the lead value, and transmitting the lead content item to the user is based on the determining. In some embodiment, the method 400 includes mapping the CPL campaign to one of a cost-per-click (CPC) model and a cost-per-mille (CPM) model, and calculating revenue for generation of the lead based on the one of the CPC model and the CPM model.

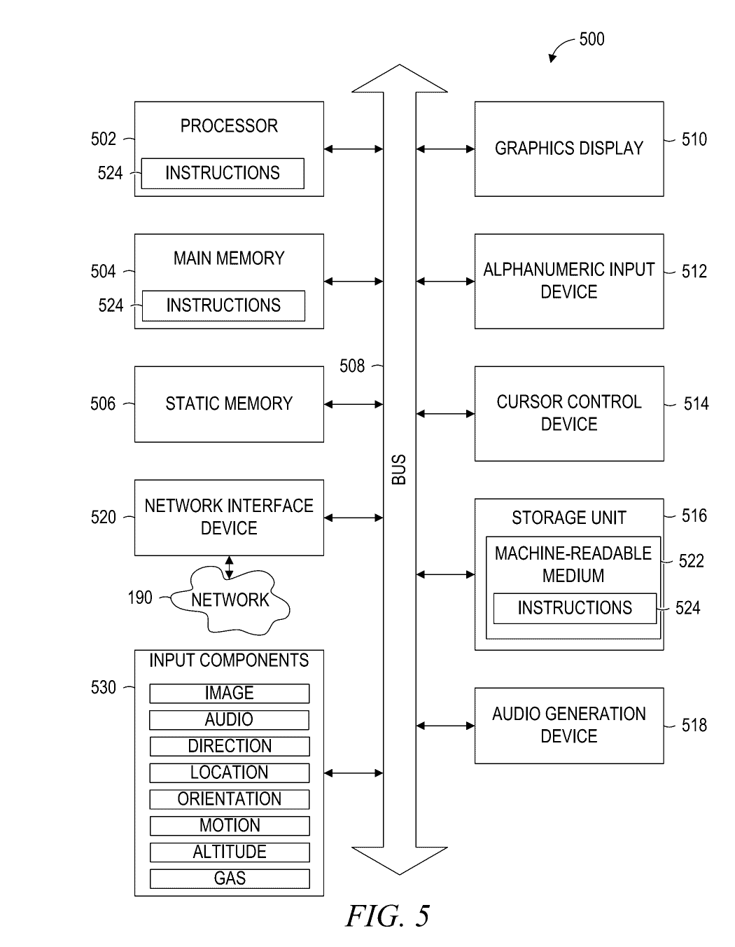

FIG. 5 is a block diagram illustrating components of a machine 500, according to some example embodiments, able to read instructions 524 from a machine-readable medium 522 (e.g., a non-transitory machine-readable medium, a machine-readable storage medium, a computer-readable storage medium, or any suitable combination thereof) and perform any one or more of the methodologies discussed herein, in whole or in part. In some embodiments, the machine 500 is similar to the networked system 105, or the social network system 210, or the lead generation engine 206. Specifically, FIG. 5 shows the machine 500 in the example form of a computer system (e.g., a computer) within which the instructions 524 (e.g., software, a program, an application, an applet, an app, or other executable code) for causing the machine 500 to perform any one or more of the methodologies discussed herein may be executed, in whole or in part.

In alternative embodiments, the machine 500 operates as a standalone device 130, 150 or may be connected (e.g., networked) to other machines. In a networked deployment, the machine 500 may operate in the capacity of a server machine 110 or a client machine in a server-client network environment, or as a peer machine in a distributed (e.g., peer-to-peer) network environment. The machine 500 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 524, sequentially or otherwise, that specify actions to be taken by that machine. Further, while only a single machine 500 is illustrated, the term “machine” shall also be taken to include any collection of machines 500 that individually or jointly execute the instructions 524 to perform all or part of any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a graphics display 510 (e.g., a plasma display panel (PDP), a light emitting diode (LED) display, a liquid crystal display (LCD), a projector, a cathode ray tube (CRT), or any other display capable of displaying graphics or video). The machine 500 may also include an alphanumeric input device 512 (e.g., a keyboard or keypad), a cursor control device 514 (e.g., a mouse, a touchpad, a trackball, a joystick, a motion sensor, an eye tracking device, or another pointing instrument), a storage unit 516, an audio generation device 518 (e.g., a sound card, an amplifier, a speaker, a headphone jack, or any suitable combination thereof), and a network interface device 520.

The storage unit 516 includes the machine-readable medium 522 (e.g., a tangible and non-transitory machine-readable storage medium) on which are stored the instructions 524 embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered machine-readable media 522 (e.g., tangible and non-transitory machine-readable media). The instructions 524 may be transmitted or received over the network 190 via the network interface device 520. For example, the network interface device 520 may communicate the instructions 524 using any one or more transfer protocols (e.g., Hypertext Transfer Protocol (HTTP)).

In some example embodiments, the machine 500 may be a portable computing device, such as a smartphone or tablet computer, and may have one or more additional input components 530 (e.g., sensors or gauges). Examples of such input components 530 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 530 may be accessible and available for use by any of the modules described herein.

As used herein, the term “memory” refers to a machine-readable medium 522 able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions 524. The term “machine-readable medium” shall also be taken to include any medium, or combination of multiple media, that is capable of storing the instructions 524 for execution by the machine 500, such that the instructions 524, when executed by one or more processors of the machine 500 (e.g., processor 502), cause the machine 500 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 522 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors 502) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 502 or other programmable processor 502. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 502 configured by software to become a special-purpose processor, the general-purpose processor 502 may be configured as respectively different special-purpose processors (e.g., comprising different hardware modules) at different times. Software (e.g., a software module) may accordingly configure one or more processors 502, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 508) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 502 that are temporarily configured (e.g., by software) or permanently configured to perform the relevant operations. Whether temporarily or permanently configured, such processors 502 may constitute processor-implemented modules that operate to perform one or more operations or functions described herein. As used herein, “processor-implemented module” refers to a hardware module implemented using one or more processors 502.

Similarly, the methods described herein may be at least partially processor-implemented, a processor 502 being an example of hardware. For example, at least some of the operations of a method may be performed by one or more processors 502 or processor-implemented modules. As used herein, “processor-implemented module” refers to a hardware module in which the hardware includes one or more processors 502. Moreover, the one or more processors 502 may also operate to support performance of the relevant operations in a “cloud computing” environment or as a “software as a service” (SaaS). For example, at least some of the operations may be performed by a group of computers (as examples of machines 500 including processors 502), with these operations being accessible via a network 190 (e.g., the Internet) and via one or more appropriate interfaces (e.g., an application programming interface (API)).

The performance of certain operations may be distributed among the one or more processors 502, not only residing within a single machine 500, but deployed across a number of machines 500. In some example embodiments, the one or more processors 502 or processor-implemented modules may be located in a single geographic location (e.g., within a home environment, an office environment, or a server farm). In other example embodiments, the one or more processors 502 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 500. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 500 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A social network system comprising:
a machine-readable memory storing:
computer-executable instructions; and
a plurality of member data elements associated with a member of the social network service; and
one or more hardware processors in communication with the machine-readable memory that, having executed the computer-executable instructions, configure the social network system to:
provide an interface to a content provider, the interface allowing the content provider to define a lead rule for a cost-per-lead (CPL) campaign of the content provider, the lead rule including a lead action and a lead content item, the lead action identifies a member action on the social network system relative to the lead content item;
receive the defined lead rule into the memory;
activate the CPL campaign including the defined lead rule;
transmit the lead content item to the member;
receive an indication that the member has performed the lead action relative to the lead content item; and
provide the member as a lead to the content provider under the CPL campaign, including providing a first member data element of the plurality of member data elements to the content provider.

2. The social network system of claim 1, wherein the lead action includes only a single click input action, wherein providing the member as a lead includes providing the first member data element in response to the single click input action.

3. The social network system of claim 1, wherein the lead action includes one or more of downloading a content item and requesting installation of an application.

4. The social network system of claim 1, wherein transmission of the lead content item to the member further includes requesting member input data associated with the lead, wherein the lead action includes receiving the member input data, the first member data element being the member input data.

5. The social network system of claim 4, wherein the lead action includes one or more of registering for an offering and submitting a request for information.

6. The social network system of claim 1, wherein the one or more hardware processors are further configured to:
receive a lead value associated with the CPL campaign, the lead value identifying a dollar value for providing the lead to the content provider; and
determine the member from a plurality of members based on the lead value,
wherein transmitting the lead content item to the member is based on the determining.

7. The social network system of claim 1, wherein the one or more hardware processors are further configured to:
map the CPL campaign to one of a cost-per-click (CPC) model and a cost-per-mille (CPM) model; and
calculate revenue for generation of the lead based on the one of the CPC model and the CPM model.

8. A computer-implemented method comprising:
providing an interface to a content provider, the interface allowing the content provider to define a lead rule for a cost-per-lead (CPL) campaign of the content provider, the lead rule including a lead action and a lead content item, the lead action identifies a member action on the social network system relative to the lead content item;
receiving the defined lead rule into the memory;
activating the CPL campaign including the defined lead rule;
transmitting the lead content item to the member;
receiving an indication that the member has performed the lead action relative to the lead content item; and
providing the member as a lead to the content provider under the CPL campaign, including providing a first member data element of the plurality of member data elements to the content provider.

9. The method of claim 8, wherein the lead action includes only a single click input action, wherein providing the member as a lead includes providing the first member data element in response to the single click input action.

10. The method of claim 8, wherein the lead action includes one or more of downloading a content item and requesting installation of an application.

11. The method of claim 8, wherein transmission of the lead content item to the member further includes requesting member input data associated with the lead, wherein the lead action includes receiving the member input data, the first member data element being the member input data.

12. The method of claim 11, wherein the lead action includes one or more of registering for an offering and submitting a request for information.

13. The method of claim 8, further comprising:
receiving a lead value associated with the CPL campaign, the lead value identifying a dollar value for providing the lead to the content provider; and
determining the member from a plurality of members based on the lead value,
wherein transmitting the lead content item to the member is based on the determining.

14. The method of claim 8, further comprising:
mapping the CPL campaign to one of a cost-per-click (CPC) model and a cost-per-mille (CPM) model; and
calculating revenue for generation of the lead based on the one of the CPC model and the CPM model.

15. A non-transitory machine-readable medium storing processor-executable instructions which, when executed by one or more hardware processors, cause a system to perform a plurality of operations, the plurality of operations comprising:
providing an interface to a content provider, the interface allowing the content provider to define a lead rule for a cost-per-lead (CPL) campaign of the content provider, the lead rule including a lead action and a lead content item, the lead action identifies a member action on the social network system relative to the lead content item;
receiving the defined lead rule into the memory;
activating the CPL campaign including the defined lead rule;
transmitting the lead content item to the member;
receiving an indication that the member has performed the lead action relative to the lead content item; and
providing the member as a lead to the content provider under the CPL campaign, including providing a first member data element of the plurality of member data elements to the content provider.

16. The machine-readable medium of claim 15, wherein the lead action includes only a single click input action, wherein providing the member as a lead includes providing the first member data element in response to the single click input action.

17. The machine-readable medium of claim 15, wherein the lead action includes one or more of downloading a content item and requesting installation of an application.

18. The machine-readable medium of claim 15, wherein transmission of the lead content item to the member further includes requesting member input data associated with the lead, wherein the lead action includes receiving the member input data, the first member data element being the member input data, wherein the lead action includes one or more of registering for an offering and submitting a request for information.

19. The machine-readable medium of claim 15, wherein the plurality of operations further comprises:
receiving a lead value associated with the CPL campaign, the lead value identifying a dollar value for providing the lead to the content provider; and
determining the member from a plurality of members based on the lead value,
wherein transmitting the lead content item to the member is based on the determining.

20. The machine-readable medium of claim 15, wherein the plurality of operations further comprises:
mapping the CPL campaign to one of a cost-per-click (CPC) model and a cost-per-mille (CPM) model; and
calculating revenue for generation of the lead based on the one of the CPC model and the CPM model.
